(19) United States
(12) Patent Application Publication
(10) Pub. No.: US 2004/0035373 A1
(43) Pub. Date: Feb. 26, 2004

(54) Economizing system for power apparatus of engines

(76) Inventor: Wen-Pin Sun, Ta Liao Hsiang (TW)

Correspondence Address: Leong C. LEI, PMB #1008, 1867 Ygnacio Valley Road, WALNUT CREEK, CA, 94598-3214, US

(21) Appl. No.: 10/225,355

(22) Filed: Aug. 22, 2002

(51) Int. Cl. F02B 43/08

(52) U.S. Cl. 123/3

(57) ABSTRACT

This invention is concerning a type of oil-economizing system of power apparatus for engines where the desired 30% oil gas is supplied by the source oil tank, wherein an oil gas chamber connected to oil tank with a heating element erected at the lower portion in its interior can heat and turn the highly volatile fuel into a more stable oil gas, the oil gas then is carried over to a gas conditioning compartment for air mixing to become a leaner oil gas in order to supply the 70% oil gas and mingle with the oil gas given from source oil supply system and deliver the oil gas in full required for the combustible explosion in engine; it not only enhances the efficiency of combustible explosion for engine with more than 60% oil saving efficacy achievable, but it also produces no air pollution due to its 100% combustion so that the objective of environmental protection is accomplishable.

### BACKGROUND OF THE INVENTION

1. Field of the Invention

This invention is related to an economizing system for power apparatus of engine.

2. Description of the Prior Art

With the economic recession plus the increasingly growing unemployment rate, it encourages people the concept of frugality, how to retrench the dispensable expenses is becoming a crucial issue indeed. People in nowadays society most probably takes the vehicle as the tool of transportation where the power of vehicle comes from the engine; and the energy to drive engine to do the work is the fuel. The power generated by the work of engine can be divided into two types of system generally, please refer to FIG. 1 for one of them, the fuel is carried to carburetor for vaporizing the fuel and mixing with the fresh air induced from air filter to form the oil gas, then the oil gas is supplied to the combustion chamber inside the engine for ignition and combustible explosion so as to energize the reciprocal movement of piston and produce power accordingly. Another type of jet engine is shown on FIG. 2, the oil is coming out in atomized state as the nozzles inside the engine intermittently perform their action of oil injection and atomization; in the meantime, the incoming fresh air from carburetor is induced into engine together, and after performing the ignition and combustible explosion, it can drive the piston to do reciprocating motion to generate power; however, when the vehicle is in use, according to the authentication from scholars and experts, it has merely 30% fuel authentically converted into power while the rest of 70% fuel has been depleted because of the incomplete combustion or other factors. This phenomenon is a meaningless squander, especially for those vehicles of 7, or 8 years old, they are not only burdened the oil consumption volume, but they also are to create a severe pollution to the environment; thus, how to elevate the utilizing efficiency of fuel and save the inadequate squander is a topic waiting for an urgent settlement essentially.

### SUMMARY OF THE INVENTION

The first and foremost objective of this invention is to offer an oil-economizing system for the power apparatus of engine by making the use of 30% oil gas supplied by the source oil tank, and a oil gas chamber is heated to turn the fuel in highly volatility inside the chamber into a more stable oil gas, and then carry this oil gas in high concentration over to a gas conditioning compartment for mixing with air to form a leaner oil gas in order to supply the 70% oil gas and mingle with the oil gas given from source oil supply system and deliver the oil gas in full required for the combustible explosion in engine; it not only enhances the efficiency of combustible explosion for engine with more than 60% oil saving efficacy achievable, but it also produces no air pollution due to its 100% combustion so that the objective of environmental protection is accomplishable.

### BRIEF DESCRIPTION OF THE DRAWINGS

FIG. 1 is a schematic diagram showing a conventional fuel supply for engines;

FIG. 2 is a schematic diagram showing another conventional fuel supply for engines;

FIG. 3 is a schematic diagram showing a preferred embodiment according to the present invention; and

FIG. 4 is a schematic diagram showing another preferred embodiment according to the present invention.

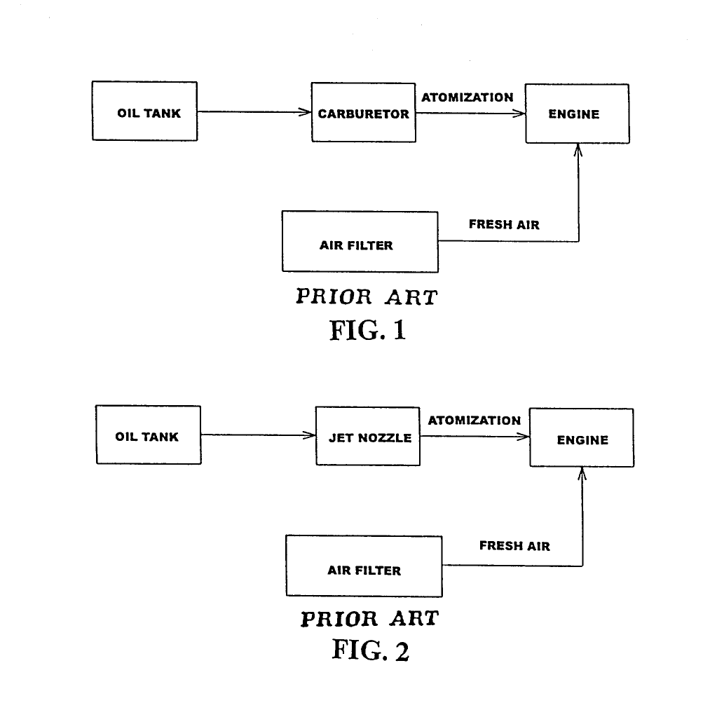

### DETAILED DESCRIPTION OF THE PREFERRED EMBODIMENT

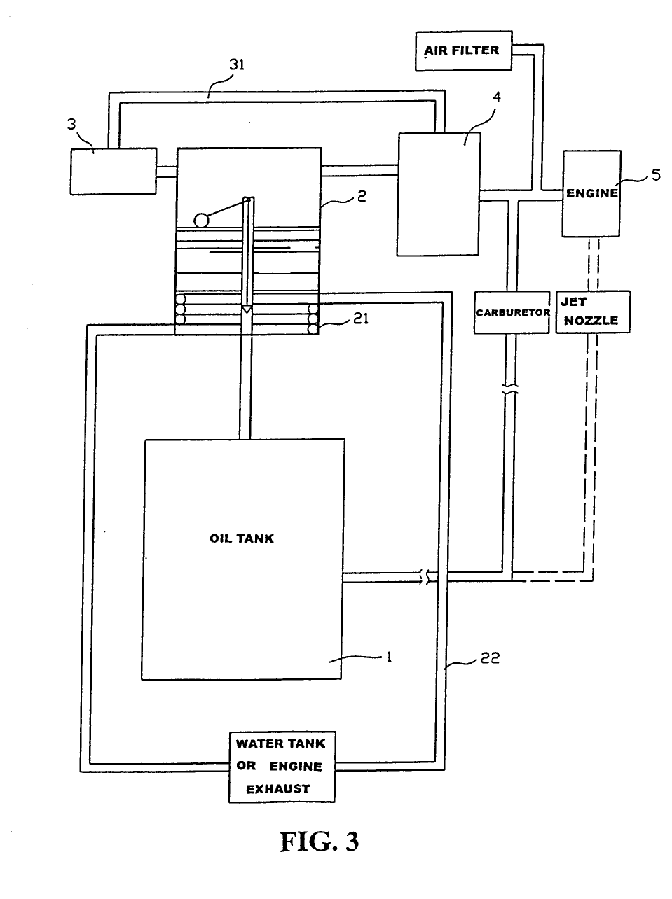

Please see the FIG. 3 for the system of this invention, it mainly mounts a pipeline 11 to connect the oil gas chamber 2 in addition to the original oil supply pipeline of oil tank 1 in order to carry the fuel in oil tank 1 to the oil chamber 2 where there has heating coil 21 fitted at the lower interior side of oil gas chamber 2, the tip of heating pipeline 21 at both sides is extended outside the oil gas chamber 2 and jointed to a radiator or the exhaust of engine as to construct a cyclic loop, with such an arrangement, the function to heat up the interior of oil gas chamber 2 is achieved by diverting the water of high temperature in radiator or the thermal energy of exhaust flue gas from engine to flow into the heating coil 21 at oil gas chamber 2 where a 60˜70¢J state is maintained; also, a on/off valve 12 is mounted in the pipeline 11 that can keep 3/5 the oil volume of fuel flowing into the oil gas chamber 2 and leave a spare space on the upper part inside the oil gas chamber 2; an intake device 3 is installed on the upper part of one side in oil gas chamber 2 while an exhaust pipe 23 is fitted on the other side, and this exhaust pipe 23 is connected to gas conditioning compartment 4 where it is jointed to engine 5 via pipeline 41, furthermore, the intake device 3 is connected to gas conditioning compartment 4 by pipeline 32 for the purpose of supplying fresh air to gas conditioning compartment 4.

The performance of this invention is to take the advantage of the source oil supply pipeline to supply engine the 30% original fuel that will be heated up by the heating coil 21 while entering the oil gas chamber 2; as the gasoline is a fuel in high volatility, therefore, it can be heated up to compose a oil gas in high concentration, and then it is carried over to gas conditioning compartment 4 by the low pressure gas at intake device 3 via exhaust pipe 23; at the same time, the intake device 3 supply the fresh air to gas conditioning compartment 4 through pipeline 31, by blending the input fresh air and the highly concentrated oil gas, they are tuned to produce an oil gas with a leaner concentration, afterward, supply this leaned oil gas as the due 70% original oil gas; and the supplied 30% oil gas from the source oil supply pipeline is vaporized by carburetor (nozzles) and then mingled with the fresh air induced from air filter to fulfill the engine 5 with the oil gas demanded for combustible explosion.

There is no need to provide additional energy for oil gas chamber 2 to perform the heating action, thus it will not increase the energy consumption, accordingly, the oil gas in oil gas chamber 2 is possessing a higher temperature due to the heating function, with this raised temperature of oil gas, it is easily to be ignited and exploded after it is intermixed with the oil gas coming from the source oil supply pipeline and entered into the engine 4, also the efficiency is promoted as well after the combustible explosion, in so performance, the condition of incomplete combustion from oil gas is minimized; it not only gets rid of the phenomena of carbon deposit in cylinder, but it also boots the output power of engine with the efficiency of combustion enhanced; meanwhile, since the fuel is heated to form a stable oil gas in oil gas chamber 2 and conditioned to make up an oil gas with proper concentration at gas conditioning compartment 4, and then mixed with the oil gas from the source oil supply pipeline, hence, it can effectively and largely reduce the consuming volume of fuel.

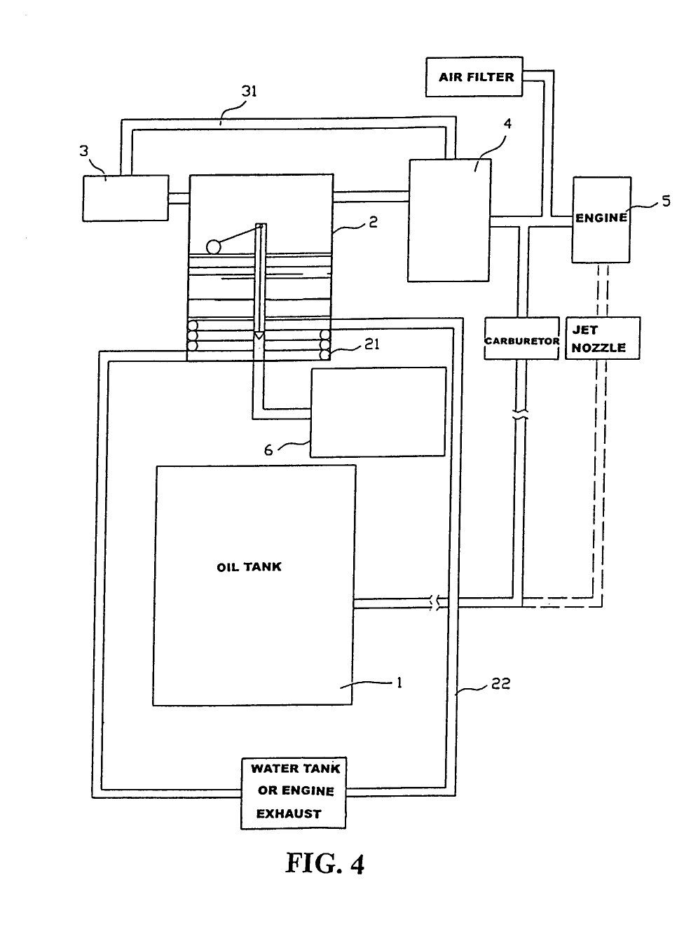

And, when the engine is applied the diesel as the fuel, owing to the diesel is a fuel of low volatility, it is not easy to become a stable oil gas after being heated, please see FIG. 4; therefore, it is necessary to mount an independent auxiliary oil tank separately to fill the oil gas chamber 2 with highly volatile fuel (gasoline), consequently, the fuel can make up a more stable oil gas after being heated that can be carried over to gas conditioning compartment 4 for dilution, mingled with the fresh air induced from air filter and the fuel supplied from the source oil supply pipeline and then input into engine for combustion explosion to deliver the power.

As synthetically concluded from the foregoing, this invention has been authentically tested step by step by the applicant, it not only truly saves the fuel consumption, but it also accomplish the demand of environmental protection, it has conformed to the industrial application, also there is no any such a structure seen in the market, thus legally file the application, it is anticipated that your esteem deliberation committee would authenticate it in details, it is highly appreciated that you grant the patent as deliberated and expected.

I claim:

1. An oil-economizing system of power apparatus of engine to mount an oil gas chamber connected to oil tank with heating coil erected at oil gas chamber so that the fuel with high volatility inside can be heated to make up a oil gas in a higher stability and concentration and carried over to a gas conditioning compartment for oil gas dilution by mixing with the outside air, afterward mingled with oil gas supplied from the source oil supply pipeline, and finally input into engine for combustion & explosion to generate power.

2. An oil-economizing system of power apparatus of engine as claimed in claim 1, wherein the source oil supply pipeline is to supply the 30% oil while the 70% oil is to be supplied by the oil gas chamber.

3. An oil-economizing system of power apparatus of engine as claimed in claim 1, wherein 60˜70 degrees centigrade is the optimum temperature in the oil gas chamber after heating.

4. An oil-economizing system of power apparatus of engine as claimed in claim 1, wherein an independent auxiliary oil tank is mounted separately when the engine is applied the diesel as the fuel in order to fill the oil gas chamber with highly volatile fuel.
